(19) United States
(12) Patent Application Publication
(10) Pub. No.: US 2009/0228790 A1
(43) Pub. Date: Sep. 10, 2009

(54) METHOD AND APPARATUS OF DISPLAYING TOUCH BUTTON PANEL FOR MOBILE APPARATUS

(76) Inventor: Yi-Hsi CHIU, Taoyuan City (TW)

Correspondence Address: HDLS Patent & Trademark Services, P.O. BOX 220746, CHANTILLY, VA, 20153-0746, US

(21) Appl. No.: 12/119,603

(22) Filed: May 13, 2008

(30) Foreign Application Priority Data
Mar. 4, 2008 (TW) 097107482

(51) Int. Cl. G06F 3/048

(52) U.S. Cl. 715/702

(57) ABSTRACT

An apparatus of displaying a touch button panel for a mobile apparatus includes a first shell and a second shell. The first shell installs a touch-screen display thereon. The second shell is shorter than the first shell and the second shell is mechanically connected to the first shell so that a portion of the touch-screen display is exposed. An inner program of the mobile apparatus is provided to determine whether the second shell has a position shift or not. The exposed touch-screen display is provided to display icons of a first touch button panel when the second shell has not a position shift. The touch-screen display of the first shell is completely exposed to simultaneously display icons of the first touch button panel and icons of a second touch button panel when the second shell has a position shift.

### BACKGROUND OF THE INVENTION

1. Field of the Invention

The present invention relates to a screen display, and more particularly to a screen display of displaying touch button panels for a mobile apparatus.

2. Description of the Prior Art

Recently with the rapid improvement of 3G-generation mobile phone, various multimedia applications, such as video/voice communication, Internet surfing, games, mobile TV, and so on, are integrated in the 3G mobile phone. Hence, a suitable screen display of the mobile phone is an essentially demand for users. For this reason, it needs to not only raise resolution of the screen display but also enlarge size of the screen display.

Reference is made to FIG. 1a and FIG. 1b which are a front view of a prior art mobile phone and an operation schematic view of the prior art mobile phone, respectively. A touch button cluster 102 comprises directional buttons, an End button, an Answer button, and functional buttons. The touch button cluster 102 is installed on a lower portion of an upper shell 101 of the mobile phone 10 to enlarge size of a screen display 103. Another touch button cluster 105 is installed on a lower shell 104, and the touch button cluster 105 is exposed for operation when the upper shell 101 has a position shift.

However, the design of the upper shell 101 and the lower shell 104 makes a complicated structure for the mobile phone 10 and difficulty for manufacturing. Besides, the mobile phone can only install one screen display 103 for operating.

### SUMMARY OF THE INVENTION

Accordingly, a primary object of the present invention is to provide a screen display of a mobile apparatus to display icons of touch button panel. Different shells of the mobile apparatus are mechanically connected to enlarge available region of the screen display. In addition, the uncovered portion of the screen display is provided to display icons, such as directional button icons, an End button icon, an Answer button icon, functional buttons icons, and so on. Furthermore, the mobile apparatus can install at least one screen display.

In order to achieve the objectives mentioned above, the mobile apparatus comprises a first shell and a second shell. The first shell installs a touch-screen display on a front surface thereof. The second shell is mechanically connected to the first shell and the second shell is shorter than the first shell so that a portion of the touch-screen display of the first shell is exposed.

In order to achieve the objectives mentioned above, a method of displaying the touch button panel for the mobile apparatus comprises: Firstly, it is to determine whether the second shell has a position shift or not. The exposed touch-screen display is provided to display icons of a first touch button panel when the second shell has not a position shift. The touch-screen display is completely exposed to simultaneously display icons of the first touch button panel and icons of a second touch button panel when the second shell has a position shift.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The above and further advantages of this invention may be better understood by referring to the following description, taken in conjunction with the accompanying drawings, in which:

FIG. 1a is a front view of a prior art mobile phone;

FIG. 1b is an operation schematic view of the prior art mobile phone;

FIG. 2 is a perspective view of a mobile apparatus according to the present invention;

FIG. 3 is a front view of the mobile apparatus;

FIG. 4 is a front schematic view of producing a position shift for a second shell;

FIG. 5 is a perspective view from another view of producing a position shift for the second shell;

FIG. 6 is a flowchart of displaying a touch button panel;

FIG. 7 is a perspective view of a mobile apparatus of another embodiment;

FIG. 8 is an operation schematic view of FIG. 7;

FIG. 9 is a front view of a mobile apparatus of another further embodiment; and

FIG. 10 is an operation schematic view of FIG. 9.

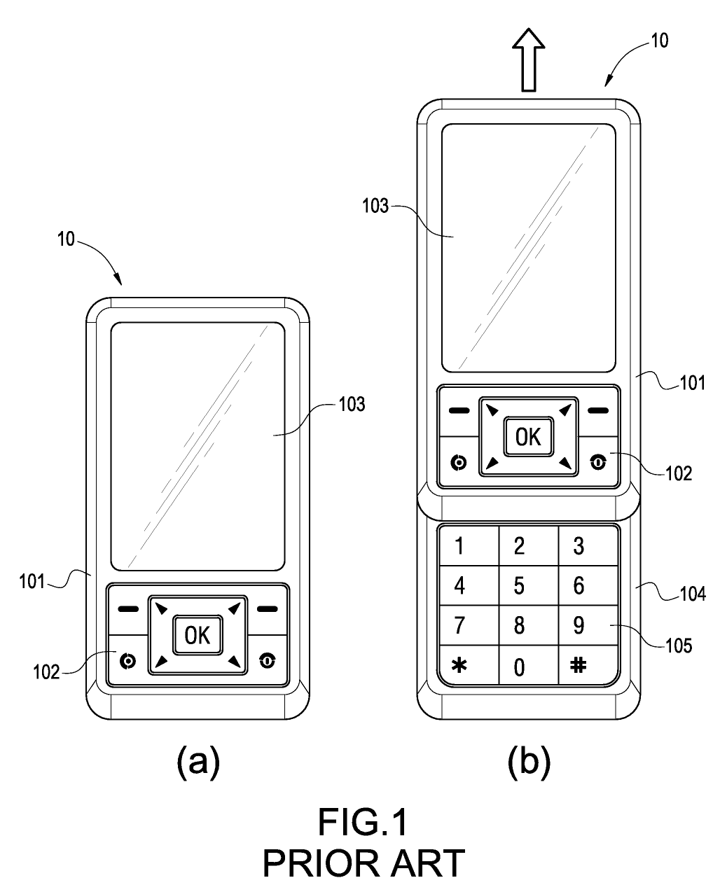

The drawings will be described further in connection with the following detailed description of the present invention.

### DETAILED DESCRIPTION OF THE INVENTION

Reference will now be made to the drawing figures to describe the present invention in detail.

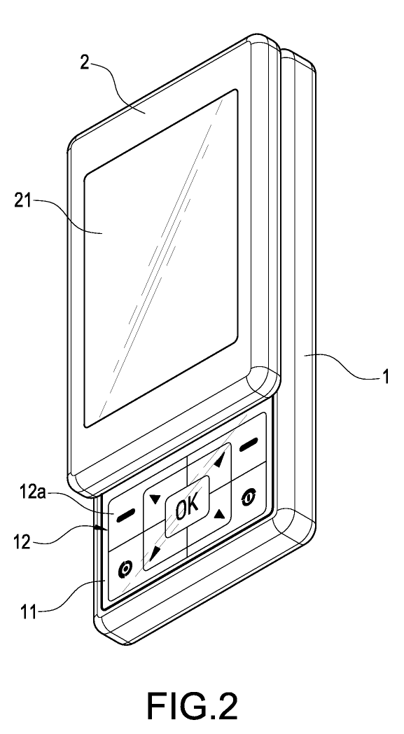

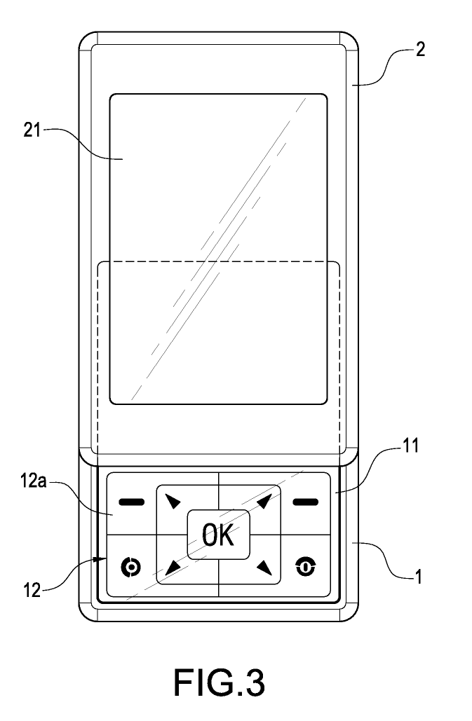

Reference is made to FIG. 2 and FIG. 3 which are a perspective view of a mobile apparatus and a front view of the mobile apparatus, respectively. The mobile apparatus comprises a first shell 1 and a second shell 2, and the second shell 2 is used as an upper shell for the mobile apparatus.

The first shell 1 installs a touch-screen display 11 on a front surface thereof, and the touch-screen display 11 is provided to display various touch button icons 12 and image frames. When the touch button icons 12 are displayed on the touch-screen display 11, operators can touch the touch button icons 12 to generate corresponding signals to the first shell 1. The signals are processed by a program of a controller (not shown) in the first shell 1. The touch button icons 12 can be a Button panel icon, a File folder icon, a Page icon, and so on. The touch-screen display 11 is comprised of a liquid crystal display and a touch panel, and the touch panel is a resistive touch panel or a capacitive touch panel.

The second shell 2 is mechanically connected to the first shell 1 by using a sliding mechanism. The second shell 2 installs a screen display 21 on a front surface thereof, and the screen display 21 is provided to display number icons, character icons, or symbol icons. In this embodiment, the second shell 2 is pivotally engaged on the front surface of the first shell 1. Because the second shell 2 is shorter than the first shell, the touch-screen display 11 of the first shell 1 is partially exposed. An exposed portion of the touch-screen display 11 displays icons of a first touch button panel 12a, such as directional button icons, an End button icon, an Answer button icon, functional buttons icons, and so on. At this time, the second shell 2 does not have position shift and entirely rests on the first shell 1.

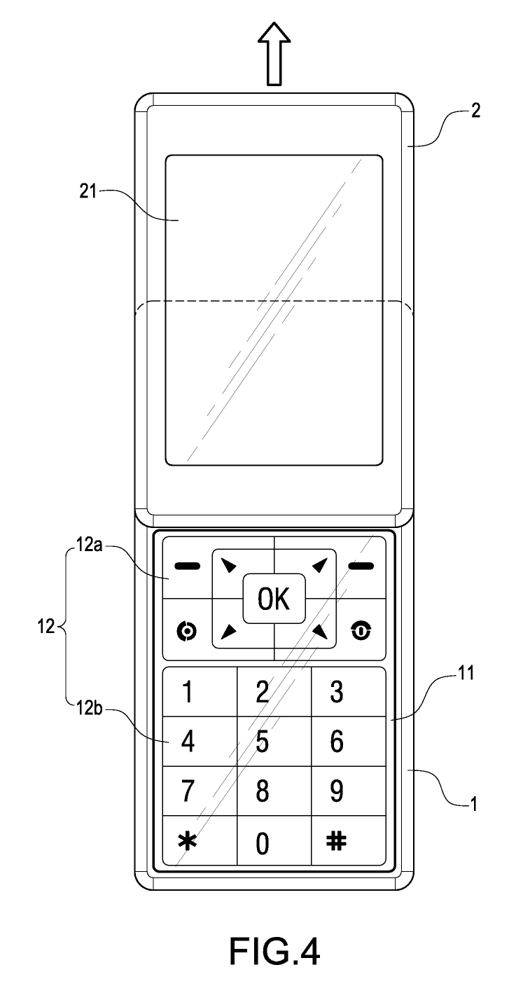

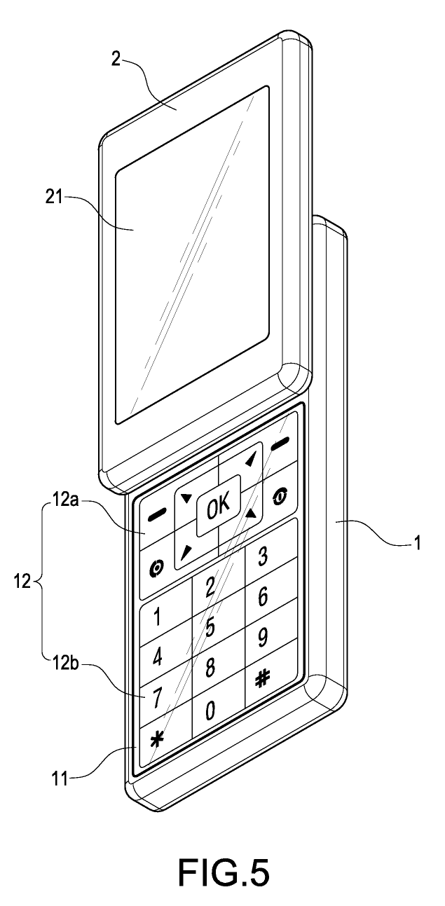

Reference is made to FIG. 4 and FIG. 5 which are a front schematic view of a second shell with a position shift and a perspective view from another view for the second shell with a position shift, respectively. The first touch button panel 12a is displayed on an upper portion of the touch-screen display 11 and a second touch button panel 12b is displayed on a lower portion of the touch-screen display 11 when the touch-screen display 11 of the first shell 1 is completely exposed. Moreover, the first touch button panel 12a can be displayed on the lower portion of the touch-screen display 11 and the second touch button panel 12b can be displayed on the upper portion of the touch-screen display 11 when the touch-screen display 11 of the first shell 1 is completely exposed. The first touch button panel 12a and the second touch button panel 12b are controlled by an internal circuit (not shown) of the first shell 1. Hence, a complete operation button panel of the mobile apparatus is formed by combining the first touch button panel 12a and the second touch button panel 12b. The second touch button panel 12b displays number icons, character icons, symbol icons.

However, the first touch button panel 12a is displayed again on the lower portion of the touch-screen display 11 when the second shell 2 is restored to the original position (without position shift) and the upper portion of the touch-screen display 11 is covered by the second shell 2.

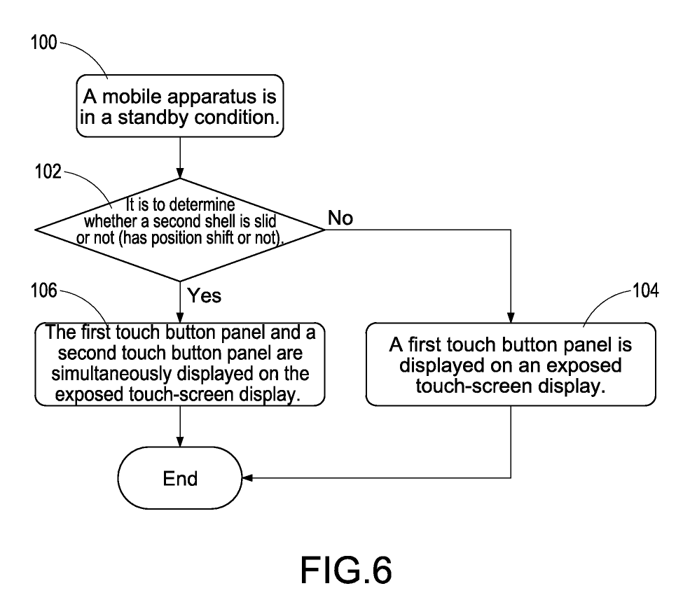

Reference is made to FIG. 6 which is a flowchart of displaying a touch button panel. Firstly, the mobile apparatus is in a standby condition (S100). Afterward, it is to determine whether the second shell is slid or not (has position shift or not) (Si02). If the second shell is not slid, the first touch button panel is displayed on the exposed touch-screen display of the first shell (S104). If the second shell is slid, the first touch button panel and the second touch button panel are simultaneously displayed on the exposed touch-screen display of the first shell (S106).

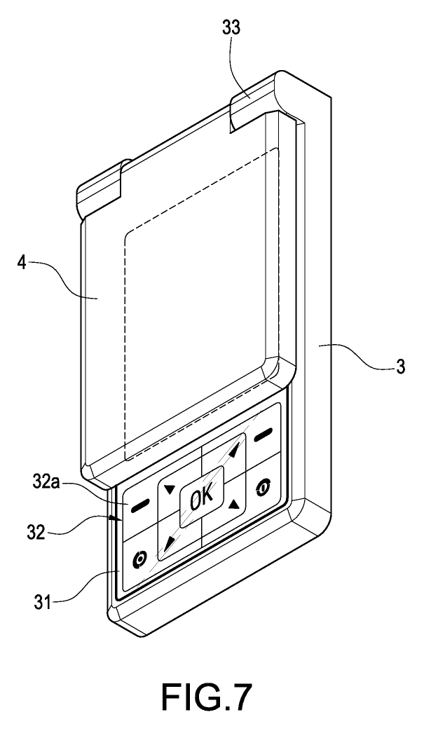

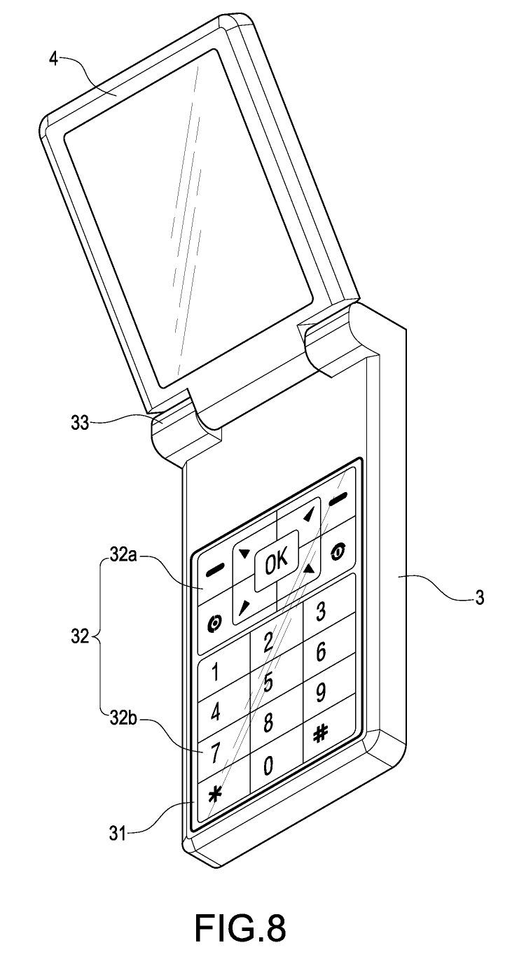

Reference is made to FIG. 7 and FIG. 8 which are a perspective view of a mobile apparatus of another embodiment and an operation schematic view of FIG. 7, respectively. The second shell 4 is mechanically connected to the first shell 3 by a hinge 33. A portion of the touch-screen display 31 of the first shell 3 is covered by the second shell 4 when the second shell 4 is not lifted. Another portion of the touch-screen display 31 is exposed to display icons of the first touch button panel 32a. The touch-screen display 31 of the first shell 3 is completely exposed to simultaneously display icons of the first touch button panel 32a and icons of a second touch button panel 32b on the touch-screen display 31 when the second shell 4 is lifted.

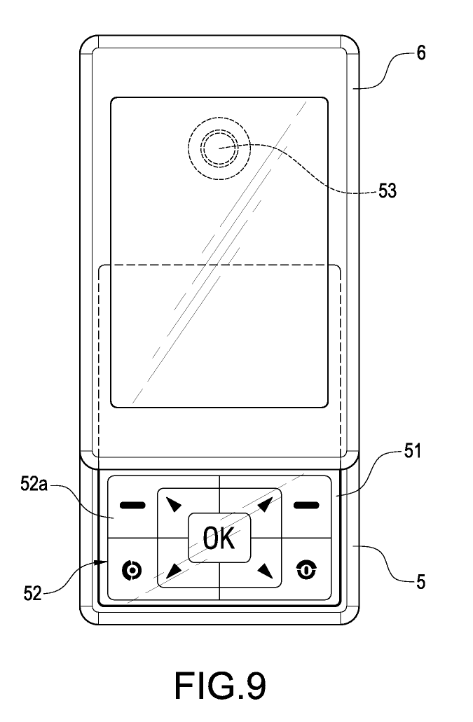

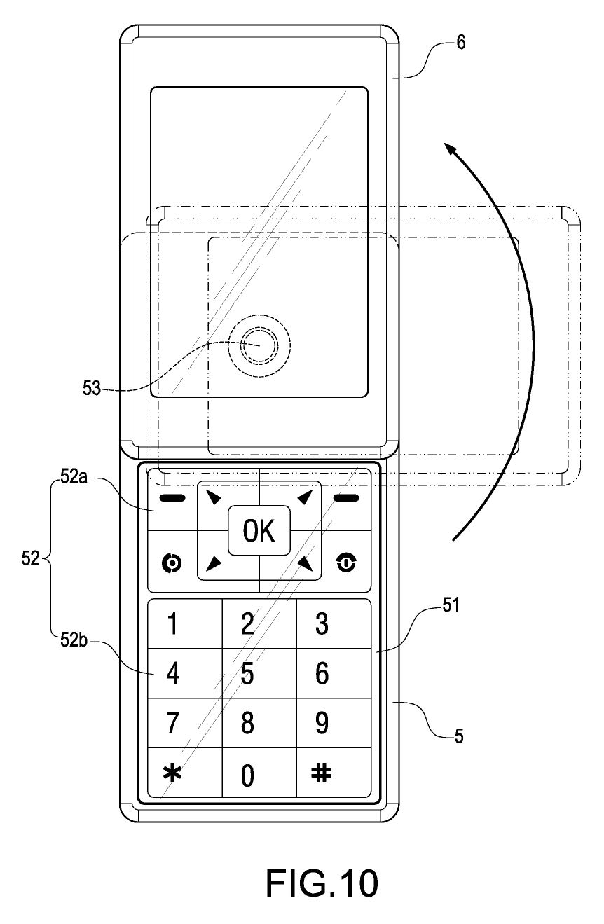

Reference is made to FIG. 9 and FIG. 10 which are a front view of a mobile apparatus of another further embodiment and an operation schematic view of FIG. 9, respectively. The second shell 6 is mechanically connected to the first shell 5 by a pivot or a hinge 53 for a rotation connection. A portion of the touch-screen display 51 of the first shell 5 is covered by the second shell 6 when the second shell 6 is not rotated. Another portion of the touch-screen display 51 is exposed to display icons of the first touch button panel 52a. The touch-screen display 51 of the first shell 5 is completely exposed to simultaneously display icons of the first touch button panel 52a and icons of a second touch button panel 52b on the touch-screen display 51 when the second shell 6 is rotated.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of displaying a touch button panel for a mobile apparatus, the mobile apparatus comprising a first shell and a second shell; the second shell is shorter than the first shell, the first shell installs a touch-screen display on a front surface thereof, and the second shell is mechanically connected to the first shell so that a portion of the touch-screen display is exposed, the method comprising the steps of:
determining whether the second shell has a position shift or not;
displaying icons of a first touch button panel on the exposed portion of the touch-screen display when the second shell does not have a position shift;
displaying simultaneously icons of the first touch button panel and icons of a second touch button panel on the exposed touch-screen display when the second shell has a position shift;

2. The display method in claim 1, wherein the icons of the first touch button panel include directional button icons, an End button icon, an Answer button icon, and functional button icons.

3. The display method in claim 1, wherein the touch-screen display further displays a File folder icon and a Page icon.

4. The display method in claim 1, wherein the touch-screen display further displays image frames.

5. The display method in claim 1, wherein the icons of the second touch button panel include number icons, character icons, and symbol icons.

6. The display method in claim 1, wherein the touch-screen display is comprised of a liquid crystal display and a touch panel.

7. The display method in claim 6, wherein the touch panel is a resistive touch panel or a capacitive touch panel.

8. The display method in claim 1, wherein the second shell installs a screen display thereon.

9. The display method in claim 1, wherein the second shell is mechanically connected to the first shell by using a sliding mechanism.

10. The display method in claim 1, wherein the second shell is mechanically connected to the first shell by a hinge for lifting the second shell.

11. The display method in claim 1, wherein the second shell is mechanically connected to the first shell by a pivot or a hinge for a rotation connection.

12. The display method in claim 1, wherein the first touch button panel is displayed on an upper portion of the touch-screen display and the second touch button panel is displayed on a lower portion of the touch-screen display when the touch-screen display of the first shell is completely exposed.

13. The display method in claim 1, wherein the second touch button panel is displayed on an upper portion of the touch-screen display and the first touch button panel is displayed on a lower portion of the touch-screen display when the touch-screen display of the first shell is completely exposed.

14. A touch button panel for a mobile apparatus, the mobile apparatus comprising:
a first shell installing a touch-screen display on a front surface thereof;
a second shell mechanically connected to the first shell, and the second shell is shorter than the first shell so that a portion of the touch-screen display of the first shell is exposed;
wherein icons of a first touch button panel are displayed on the exposed portion of the touch-screen display when the second shell has not a position shift; icons of the first touch button panel and icons of a second touch button panel are simultaneously displayed on the exposed touch-screen display when the second shell has a position shift.

15. The touch button panel for a mobile apparatus in claim 14, wherein the icons of the first touch button panel include directional button icons, an End button icon, an Answer button icon, and functional button icons.

16. The touch button panel for a mobile apparatus in claim 14, wherein the touch-screen display further displays a File folder icon and a Page icon.

17. The touch button panel for a mobile apparatus in claim 14, wherein the touch-screen display further displays image frames.

18. The touch button panel for a mobile apparatus in claim 14, wherein the icons of the second touch button panel include number icons, character icons, and symbol icons.

19. The touch button panel for a mobile apparatus in claim 14, wherein the touch-screen display is comprised of a liquid crystal display and a touch panel.

20. The touch button panel for a mobile apparatus in claim 19, wherein the touch panel is a resistive touch panel or a capacitive touch panel.

21. The touch button panel for a mobile apparatus in claim 14, wherein the second shell installs a screen display thereon.

22. The touch button panel for a mobile apparatus in claim 14, wherein the second shell is mechanically connected to the first shell by using a sliding mechanism.

23. The touch button panel for a mobile apparatus in claim 14, wherein the second shell is mechanically connected to the first shell by a hinge for lifting the second shell.

24. The touch button panel for a mobile apparatus in claim 14, wherein the second shell is mechanically connected to the first shell by a pivot or a hinge for a rotation connection.

25. The touch button panel for a mobile apparatus in claim 14, wherein the first touch button panel is displayed on an upper portion of the touch-screen display and the second touch button panel is displayed on a lower portion of the touch-screen display when the touch-screen display of the first shell is completely exposed.

26. The touch button panel for a mobile apparatus in claim 14, wherein the second touch button panel is displayed on an upper portion of the touch-screen display and the first touch button panel is displayed on a lower portion of the touch-screen display when the touch-screen display of the first shell is completely exposed.
